(19) United States
(12) Patent Application Publication
(10) Pub. No.: US 2014/0067460 A1
(43) Pub. Date: Mar. 6, 2014

(54) SYSTEM AND METHOD FOR SIMULATING RETURN

(71) Applicant: MINDHIVE INC., New York, NY (US)

(72) Inventors: Cem Atacik, Istanbul (TR); George Dalke, Claremont, NH (US); Oya Demirli, New York, NY (US); Suraj Khatwani, New York, NY (US)

(73) Assignee: MINDHIVE INC., New York, NY (US)

(21) Appl. No.: 14/012,367

(22) Filed: Aug. 28, 2013

Related U.S. Application Data
(60) Provisional application No. 61/694,643, filed on Aug. 29, 2012.

(51) Int. Cl. G06Q 10/06

(52) U.S. Cl. CPC G06Q 10/0635
USPC 705/7.28

(57) ABSTRACT

The invention generally relates to a tool for planning a communication campaign. The invention provides systems and methods for communicating through mobile devices in which a publisher can model the effectiveness of a customer's communication campaign as a function of media purchase quantity to aid the customer in selecting a purchase quantity that optimizes a ratio of return on investment to risk. The publisher can do this by providing the customer with access to a computer server system that includes a campaign management tool with an ROI simulator. In certain aspects, the invention provides a method of planning communication on mobile devices by receiving a set of communication campaign parameters, simulating effectiveness as a function of units purchased for the received parameters, and for providing the simulated effectiveness for a plurality of values for the units purchased.

### CROSS-REFERENCE TO RELATED APPLICATION

This application claims priority to U.S. Provisional Patent Application Ser. No. 61/694,643, filed Aug. 29, 2012, the contents of which are incorporated by reference.

### FIELD OF THE INVENTION

The invention generally relates to a tool for planning a communication campaign, and particularly to an ROI simulator for use in planning communication of offers via mobile devices.

### BACKGROUND

Some businesses have products that could greatly enrich the lives of people. Such a business may want to communicate the benefits of their products to people. In an existing paradigm, an business and a publisher can make a contract to show a number of ads. They may fix a price that can be based on web clicks or ad displays (“impressions”) (see, e.g., U.S. Pat. No. 8,266,006 to Hassan; U.S. Pub. 2012/0158456 to Wang; and U.S. Pub. 2006/0122879 to O'Kelley). The business, as advertiser, writes a check and the campaign runs. If the advertiser fails to get the desired result, they can write the campaign off as a failure, or write another check and run more ads.

Not only does this method of purchasing media leave many businesses dissatisfied with their results after spending money fruitlessly, mobile technologies are proving to be a challenging medium within which to communicate. There are a growing number of smartphone natives who grew up within the mobile ecosphere without first learning an antecedent technology. These consumers are adept at tuning out material that is irrelevant to their interests. Unfortunately, businesses may find that increasing the size of their media buys fails to communicate the benefits of their products within the mobile ecosphere.

### SUMMARY

The invention provides systems and methods for communicating through mobile devices in which a publisher can receive information about a business's prospective communication campaign and model the effectiveness of the campaign as a function of media purchase quantity to aid the business in selecting a purchase quantity that optimizes a ratio of return on investment (ROI) to risk for the business. The publisher can do this by providing the business with access to a computer server system that includes a campaign management tool with an ROI simulator. The system takes as input factors that include information about the businesses campaign costs (e.g., such as selling price and discount), fixed and variable, as well as risks, and uses a fixed conversion rate to model the business's ROI/risk for each of a number of different impression purchase quantities. The factors may also include prospect rate—a number or percentage of people who click on an offer but do not redeem the offer. Thus the publisher can provide an interactive, real-time campaign planning tool that can include the counter-intuitive aspect of a feature that apparently “down-sells” the business to a lower purchase quantity than what they may otherwise be considering. The publisher's tool can be used to lead the business to purchase the quantity that gives the business the most effective communication campaign as predicted by an optimal simulated ROI/risk. Since the business allocates only the necessary portion of its communication budget to the media buy, costs are saved and the business can enrich its communication efforts by developing other campaigns that pursue, for example, other niches or communicate about other products. Since the publisher is aiding the business in maximizing its return across the entire communication budget by revealing optimal ROI even where associated with low-quantity media buys, the business and publisher build trust and build a relationship that remains fruitful to both the business and publisher over time.

The ROI simulator has particular applicability in the context of a communication campaign within the mobile ecosystem where smartphone natives have no attention for communication irrelevant to their interests. In this finely-fractionated space, small media buys, if well-targeted, have great potential to effectively communicate with recipients. The campaign planning tool described herein helps a business to target a specific niche within the mobile ecosphere and select the impression quantity to purchase that maximizes ROI/risk ratio for the business for that media campaign. Embodiments of the invention offer a delivery management system that uses inputs from a business to decide whom to target. Thus a publisher can use the tool to help a business target, or to target on behalf of a business, one or any number of communication campaigns to any size receptive audience with just the right media purchase size, giving publishers and businesses the nimbleness necessary to communicate with smartphone native in the mobile ecosystem.

The ROI simulator is particularly beneficial for use with offers, as compared to advertisements, as a company may want to offer a discount that is more substantial than a discount that the company would be willing to offer in a naked advertisement (advertisement can be taken to refer to a communication of a price that is publically available, while offer can be taken to refer to communication of a deal that is available to the intended recipient). Thus, where an offer may “cost” a company, say, $50 is “sacrificed” revenue for each instance of redemption, a company may find particular value in simulating ROI prior to choosing an impression purchase quantity to aid in narrowly tailoring the offering.

In certain aspects, the invention provides a method of planning communication on mobile devices by receiving at a publisher computer system a set of communication campaign parameters. The publisher computer system is used for simulating effectiveness as a function of units purchased for the received parameters (where effectiveness may be ROI or a ratio of return to risk). A unit may be an impression, i.e., an instance of causing a communication to be delivered via a mobile device. The system may be used for providing the simulated effectiveness for a plurality of values for the units prospectively purchased and receiving from a customer an order to purchase a number of units, which preferably are impressions that include targeted offers. In some embodiments, risk is modeled as campaign cost for a 0% conversion rate and is non-linear over order quantity due to volume discounts. In a preferred embodiment, ROI/risk is modeled for a 1% conversion rate. In some embodiments, ROI/risk is modeled over a plurality of different order quantities assuming a fixed conversion rate (e.g., 1%, 5%, etc.). The simulator may be operated to determine an ROI breakeven point. A graphical user interface (GUI) can present a simulated model ratio of ROI to risk over order quantity.

The method includes showing the customer that an optimal effectiveness is provided by a number of units purchased lower than the highest of the plurality of values for the units purchased. The system can even be used to suggest to the customer to purchase fewer than the highest of the plurality of values for the units purchased.

Providing the simulated effectiveness may be done by sending data to a customer computer and causing the customer computer to show the simulated effectiveness within a display. The campaign parameters can be obtained by causing a customer computer to render a display that can be used by the customer to provide the campaign parameters.

In some embodiments, simulating effectiveness includes assuming a fixed value for a conversion rate and calculating a return based on the conversion rate and optionally one or more other variables such as a publisher's impression cost, a customer's campaign cost, others, or a combination thereof. In a preferred embodiment, the communication includes an offer and the conversion rate represents a hypothetical percentage of mobile device users to whom the offer is delivered who then redeem the offer.

Aspects of the invention provide a communication method that includes obtaining—at a publisher computer system—campaign cost information from an advertiser customer, determining a conversion rate to use (where, e.g., conversion rate includes a percentage of people that receive an offer who respond to the offer), and predicting an ROI/risk to the customer for each of a plurality of impression quantities. The prediction is based on factors that include the campaign cost, an impression cost, and the conversion rate, wherein an impression includes showing the offer to a consumer via their mobile device. The factors may include prospect rate, price, discount, life time value, others mentioned herein, similar, others, ones apparent to one of skill in the art, new variables to be developed, or combinations thereof. The method includes providing the ROI/risk for each of the different impression purchase quantities to the advertiser and receiving from the customer an order for a quantity of impressions. The method can include providing the user with an intuitive graphical user interface (GUI). For example, a customer computer can be caused to render a display for use by the customer to provide the campaign cost information, review the provided ROI/risk information, and order the quantity of impressions.

In certain embodiments, methods include providing a digital media sharing service via a plurality of mobile devices. For a plurality of users of the sharing service, information is obtained about interests of various individual ones of the users. The publisher computer system is used to aid the customer in targeting the offer based on the interests of the various individual ones of the users.

In some embodiments, a method includes showing the customer a first quantity of impressions available for purchase and suggesting to the customer to purchase a second quantity of impressions lower than the first, wherein the first quantity is associated with a first ROI/risk that is lower than the a second ROI/risk associated with the second quantity. The customer may use the GUI to change the input information and be provided with an updated ROI/risk within a few seconds of receiving the change. Campaign cost information may include any of campaign execution cost; product selling price; and discount price. The ROI/risk for each of the different impression purchase quantities may be provided within the GUI, e.g., by causing an advertiser computer to display a graph of ROI over impression quantity. The graph may have a maximum ROI/risk as well as a portion with a positive slope and a portion with a negative slope. That is, using the inventive system or method, a publisher shows a customer both the positive and the negative sloping portions of the simulated ROI/risk.

In related aspects, the invention provides a system for communicating via mobile devices. The system includes a publisher computer system with a tangible, non-transitory memory coupled to a processor. The system is operable to receive from a customer a set of communication campaign parameters, simulate return as a function of units purchased for the received parameters, and provide the simulated return for a plurality of values for the units purchased to the customer. The system can show the customer that an optimal effectiveness is provided by a number of units purchased lower than the highest of the plurality of values for the units purchased. A publisher can use the system to suggest to the customer to purchase fewer than the highest of the plurality of values for the units purchased. Preferably, simulating effectiveness comprises assuming a fixed value for a conversion rate and calculating a return based on factors such as the conversion rate, a publisher's impression cost, a customer's campaign cost, and optionally other variables. In a preferred embodiment, the communication comprises an offer and the effectiveness is calculated based on a fixed conversion rate representing a hypothetical percentage of mobile device users to whom the offer is delivered who then redeem the offer.

### BRIEF DESCRIPTION OF THE DRAWINGS

FIG. 1 shows use of a mobile device to generate new digital media.

FIG. 2 shows a device in a digital media sharing platform.

FIG. 3 depicts an exemplary registration or update screen.

FIG. 4 shows use of a media platform to share new digital media.

FIG. 5 illustrates a system for sharing media.

FIG. 6 illustrates use of device for media sharing.

FIGS. 7A-7D illustrate use of the new digital media sharing platform.

FIG. 8 depicts a home screen that may presented to a user.

FIG. 9 depicts components of system of the invention.

FIG. 10 illustrates a display on a customer computer.

FIG. 11 depicts a tool for managing an offer campaign.

FIG. 12 illustrates a sample output of an ROI simulator of the invention.

FIG. 13 diagrams steps of methods of the invention.

FIG. 14 illustrates a display through which a consumer may receive communications.

FIG. 15 gives a more detailed schematic of components that may appear within a system.

### DETAILED DESCRIPTION

The invention provides systems and methods by which a business can send targeted, timely offers to mobile consumers based on interests or profiles of the consumers. A number of factors, combinations of factors, both, and combinations thereof (factors may be taken to include combinations of factors) may be used to target offers to customers. In certain embodiments, ten or more factors are used to target offers, the factors optionally including any of interest, profile details, device data, demographic information, or any other suitable information. In some embodiments, systems and methods of the invention can be used by a publisher to provide a media distribution platform in which participant consumers share media and also receive offers that are targeted to individual consumers based on interests of the consumer. Using systems and methods of the invention, the publisher can provide businesses with a campaign management tool for designing an offer campaign in which offers are sent to consumers in a timely fashion and targeted by factors that may include interest.

Because the media distribution platform captures the attention of prospective consumers that can be targeted by matching interests to the contents of an offer, instances of presenting an offer to a customer by a publisher, or impressions, have a high likelihood of resulting a consumer's redemption of the offer, or conversion rate. Since the targeting gives impressions a high conversion rate, compared to prior art methods, impressions are valuable to businesses. To aid businesses in maximizing their value, a publisher can use systems and methods of the invention to provide an ROI/risk optimizer within the campaign management tool.

A business can use the campaign management tool to send targeted, timely offers to mobile consumers via their mobile devices based on interests or profiles of the consumers. The campaign management tool provides an affordable, easy-to-use platform by which businesses can acquire customers and manage mobile marketing campaigns. Through use of the campaign management tool, systems and methods of the invention allow businesses to optimize or improve mobile commerce ROI and to send timely, targeted, and profitable offers based on specific consumer interests. Systems and methods of the invention can be operated by a publishers to provide a variety of valuable tools such as, for example, a maximum ROI for minimum investment model; an offer management and analytics engine; a self-serviced ad-words platform for mobile marketing; real time simulation-based offer management tools to optimize risk and return prior to running campaigns; data and tools for market intelligence studies that can be conducted prior to, or without, incurring a cost; others; or a combination thereof. In certain embodiments, the campaign management tool operates as a back-end to a consumer-facing digital media sharing platform.

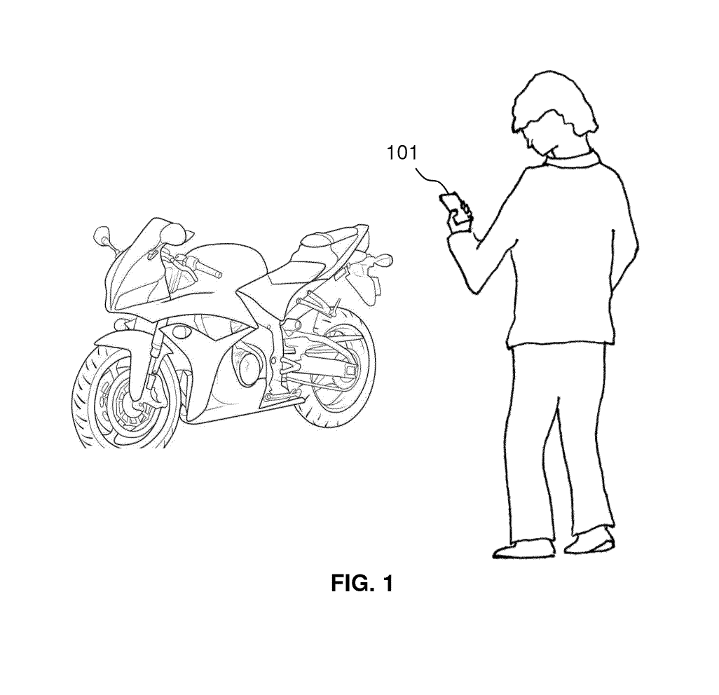

FIG. 1 shows use of a mobile device 101 to generate new digital media. In the depicted scene, a person has come across a real-world item that could be used as a subject for communication. The person takes a picture using mobile device 101, thus creating new digital media. If the person desires to communicate with friends or connections, he can engage the digital media sharing platform.

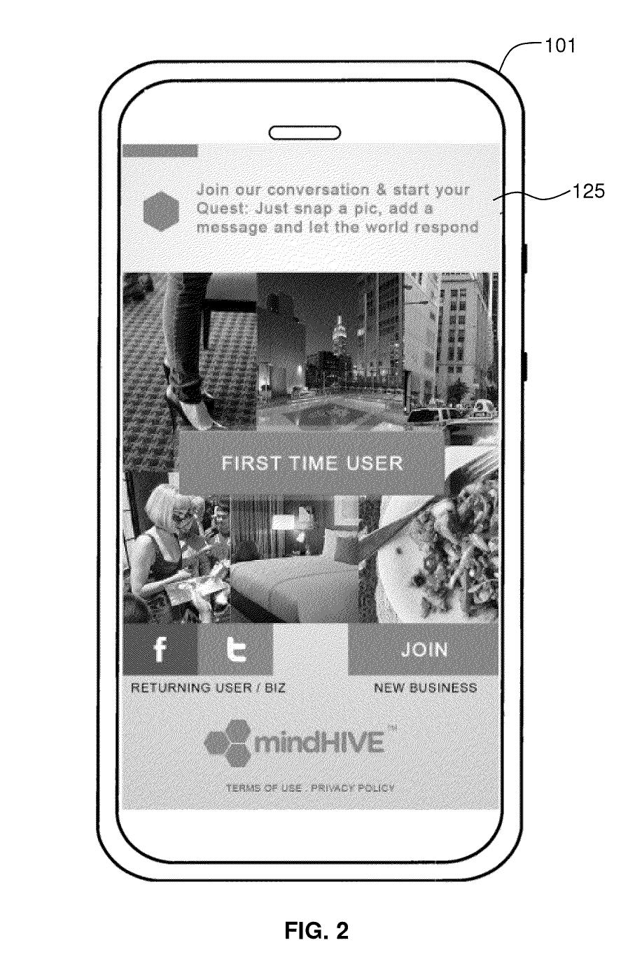

FIG. 2 shows a device 101 as viewed by a person using device 101 to engage with a digital media sharing platform. Specifically, device 101 includes a display 125 that can present interaction tools. As shown in FIG. 2, display 125 presents a screen and form that a person can use to register with a media-sharing platform (e.g., as a first-time user). One of skill in the art will recognize that any suitable registration or login screen could be presented or none. For example, in some embodiments, a person signs into the service using credentials provided by another service (e.g., “Log in using your Facesite account” is presented as an option on the screen).

Some embodiments of the invention provide a media platform that a person can use as a communication tool. Users can tailor their end of the platform to their own interests. For example, in some embodiments, a user selects one or more interests to be associated with themselves (e.g., through an account or profile).

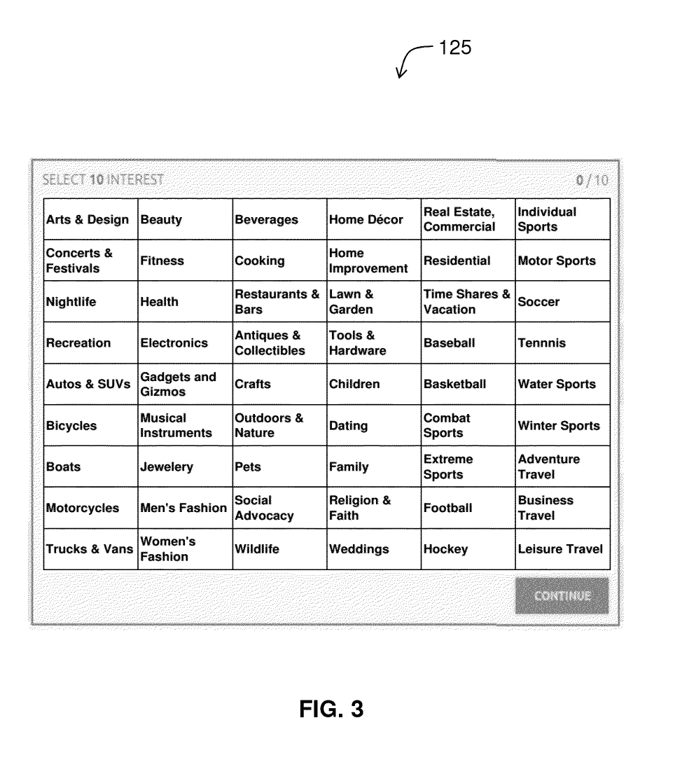

FIG. 3 depicts an exemplary registration or update screen 125 at which a user can select one or more interests to be associated with. Any suitable interests can be used such as, for example, a pre-determined list of categories; a taxonomy of nested pre-determined categories; categories derived by word-frequency analytics performed on user media; categories arrived at via a text-recognition analysis of files (e.g., pictures) within the system; category sets retrieved from other sources (e.g., “departments” listed within a shopping web site); user-entered words or titles; others; or a combination thereof.

In certain embodiments, a list of user-selectable categories is made available to a user via a screen 125 such as is shown in FIG. 3, and other categories are associated with one or more individual users via an internal business logic or rules engine. Such “behind the scenes” categories can be associated with a user by any suitable mechanism. For example, those categories shown in screen 125 in FIG. 3 can be grouped behind the scenes into meta-categories (e.g., ‘Culture’, behind the scenes, includes Arts & Designs, Concerts & Festivals, Nightlife, etc., while ‘Vehicles’ includes Autos & SUVs, Bicycles, Boats, Motorcycles, etc.) A system of the invention could include a discriminant function analysis that uses a plurality of different input information from a user to associate each user with a typifying category. For example, a function could normalize and then weight a user's self-selected categories, categories from a user's friend list, a user's demographic information from a profile, a user's location information from mobile device 101 to arrive at an index value used to a select a typifying category from a stored array. The typifying categories could include, for example, any suitable set of categories derived by a publisher's marketing team, in which each category within the set identifies a type of experience and communication that is predicted to have emotional resonance with the user. By these means, a publisher can add a layer of user-typifying classification over (or under) the user's self-identified interests, wherein the self-identified interest and the typifying classification (the X-factor) work in combination to target particular offers to particular users.

To further illustrate behind-the-scenes categories, a non-limiting example is given. A first user that is 23-years old and lives in Los Angeles and frequently posts pictures from live concerts may self-select motorcycles as an interest. A second user that is 68 years old and lives in Canton, Ohio, and frequently posts about gardening may select motorcycles as an interest. An analytical engine can associate the concert photos with a nightlife category and may also identify the second user as associated with a gardening category (behind the scenes, without self-selection by the user). The discriminant function may weight age, location, behind-the-scenes category, and may assign the first user to a typifying category of ‘adrenaline’ and the second user with a typifying category of ‘security’. One of skill in the art will recognize that the given images and words are illustrative examples only and that any suitable categories or words could be employed. The categorization functions aid in associating each user with one or more targeted interest that can be used to send targeted offers. The offers are preferably sent within the context of a user's use of the media platform. Systems and methods of the invention provide and includes a media platform with particular application in sharing new digital media.

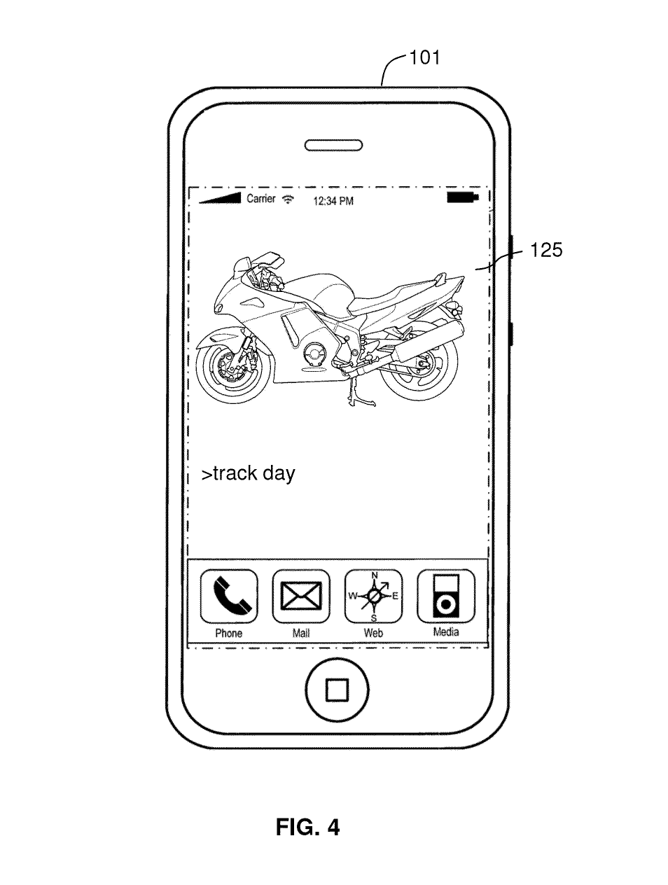

FIG. 4 shows use of a media platform to share new digital media. Here, a user has created new digital media that includes a picture just taken of an item of interest and text that the user wishes to associate with the picture. As shown in FIG. 4, the user has used mobile device 101 to compose new digital media that is being shown in display 125. The new digital media may include, for example, a picture as taken by the user shown in FIG. 1. In some embodiments, systems and methods of the invention provide a media platform that is exclusive to new digital media. Media can include pictures (still or video), sound, characters (input text or text recognized within pictures or sound), media content metadata (e.g., facial or expression recognition from within pictures), media wrapper metadata (EXIF data, time taken, etc.), extrinsic device data (location by GPS, device type), others, or a combination thereof. New can be taken to include material that is recently-created (e.g., within the last five or ten minutes). Digital generally refers to media that is capable of being stored on a tangible, non-transitory computer readable medium such as a solid state memory device (SSD, flash drive), magnetic disk drive, optical drive, or similar.

In certain embodiments, the invention includes the insight that there are desirable benefits in creating a platform for sharing new media. In some embodiments, a system of the invention is used to restrict certain sharing function to only operate with media in which one or more components of the media are newly-created (e.g., fewer than fifteen minutes ago, or five in certain embodiments). Without being bound by any theory, it may be found that users relate to a new media sharing platform as a real-time communication tool in contrast to prior art systems. Thus, in certain embodiments, systems and methods of the invention will only allow the digital media shown in display 125 on mobile device 101 in FIG. 4 to be uploaded or shared if it can be verified that the media was created within a certain amount of time ago. Once media is readied for sharing in the platform, a user can use systems and methods of the invention to share the media with recipient users.

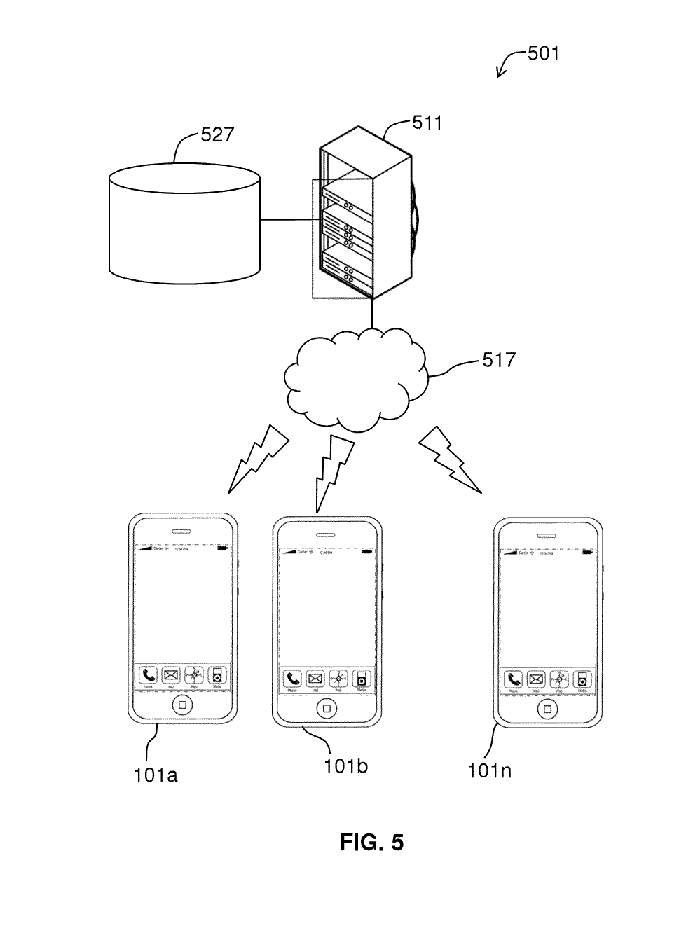

FIG. 5 illustrates a system 501 for sharing media. System 501 may include at least one server computer system 511 operable to communicate with a plurality of devices 101a, 101b, . . . , 101n via communication network 517. Optionally, storage 527 may be associated with system 501. Components of system 501, such as server system 511, can be operated to receive media from a user and publish that media for recipients.

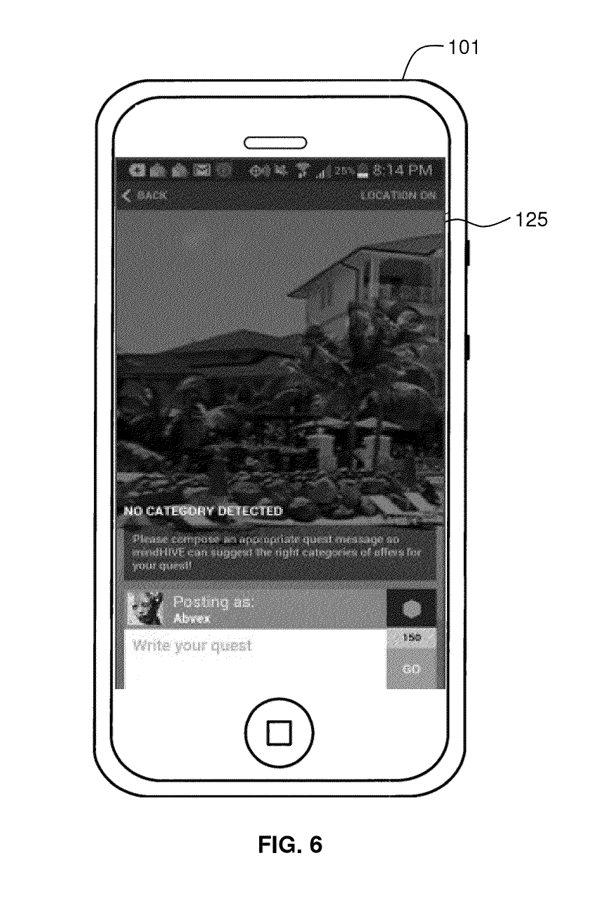

FIG. 6 illustrates use of device 101 for media sharing through a publisher's system. As shown in FIG. 6, a user has captured and is uploading a picture using mobile device 101. Here, the picture shows a resort that the user has snapped a picture of using a mobile device 101. Display 125 shows the picture as it will be shared, and also includes prompts suggesting that the user associate a message with the picture. Display 125 further includes a text input field, other switches (e.g., location of/off), and buttons. In the depicted embodiment, the user is using the media platform to communicate with friends using the picture. In a hypothetical scenario, the user has stumbled upon the depicted vacation resort and wishes to ask her friends if they are familiar with the resort or location. The user snaps a picture of the building and uploads the newly-created digital media into the platform and composes a supplemental message to be published with the picture.

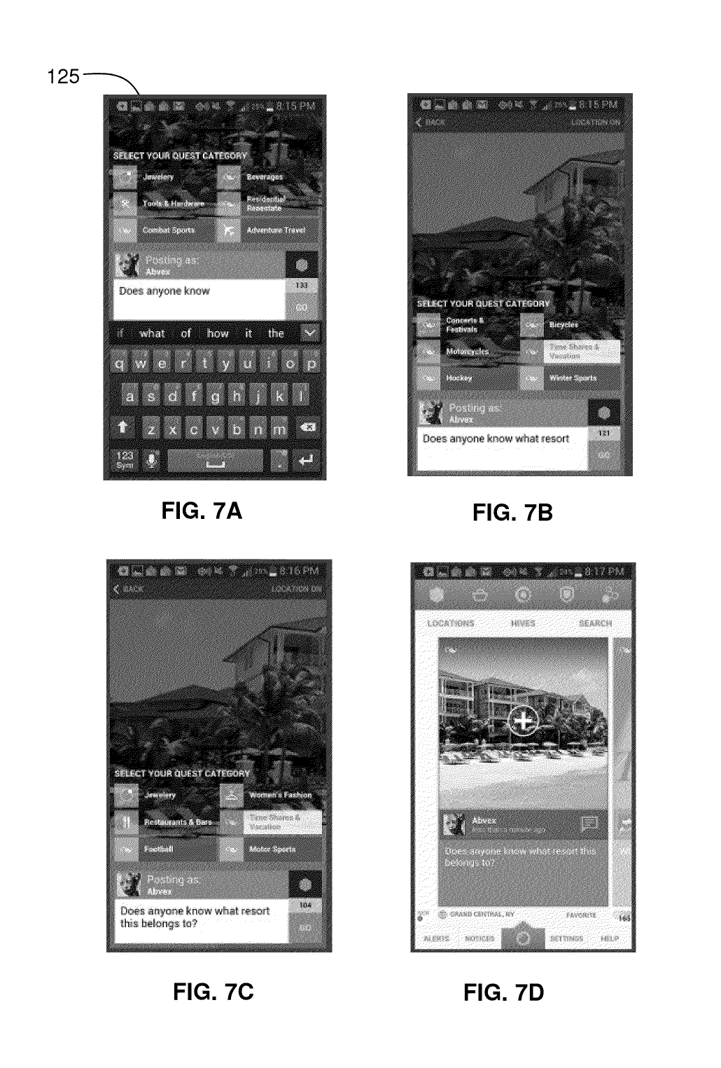

FIGS. 7A-7D illustrate use of the new digital media sharing platform by a user to communicate with one or more friends or recipients. Once the user has uploaded the picture, the system can prompt the user to enter text, as shown in FIG. 6. As the user enters text, the system can suggest categories for the user to select based on analysis of the nascent digital media—the picture and text and associated data—as shown in FIG. 7A. As illustrated by FIG. 7B, as the user continues composition of the text message, the system refines the proposed categories. In FIG. 7C, the user has completed composition of the text message. The new media has been published to its intended recipients. The user may proceed to take a new picture and create additional media for communication.

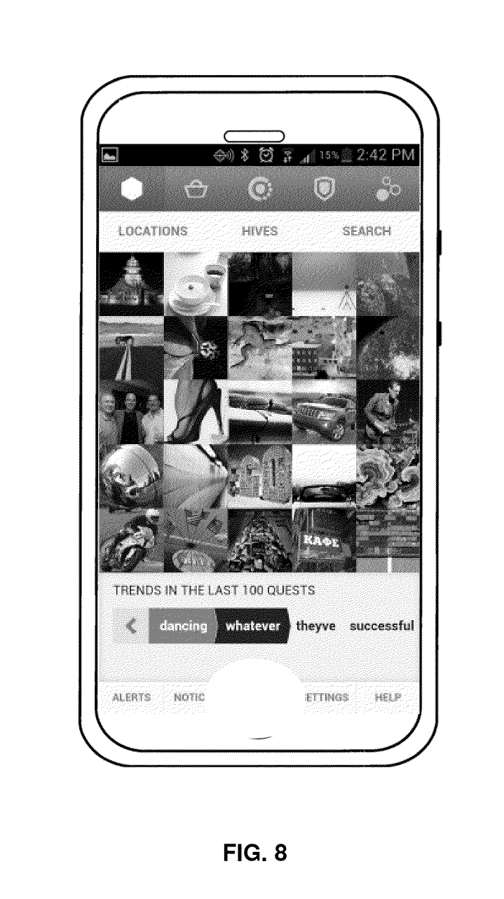

FIG. 8 depicts a home screen that may be presented to a user. Here, a user can search for items of interest, get information about their friends, or follow recent trends. In the depicted embodiments, media sharing may be styled as quests and categories may be styled as hives. But it will be recognized that any suitable front end can be used to engage a user.

Since a publisher can use the media platform to engage users within media sharing networks (e.g., “hives” in FIG. 8) that can be narrowly tailored to the particular interests of a user at that time, communication through the media platform can be made to have particular relevance to individual users. For example, a business that wanted to send a communication about Victorian era dollhouses, or about current air fares to Paris, could have those communications sent to users for whom it had been determined that they would be interested in the subject matter. In some embodiments, it may be found that limiting the media sharing platform to new digital media greatly increases the tailoring of interests presently associated with the user and thus the relevance of communication through the platform. Since communication through the platform can have particular relevance, that communication may be found to be particularly effective. Since the systems and methods of the invention offer a platform for effective communication, a business may find that transmitting offers targeted to users through the platform is a desirable method of connecting users to goods and services that may enrich their lives. In some embodiments, systems and methods of the invention provide an offer campaign management tool that businesses or other entities (e.g., non-profits or governments) may use to plan and execute a campaign that includes sending offers to users.

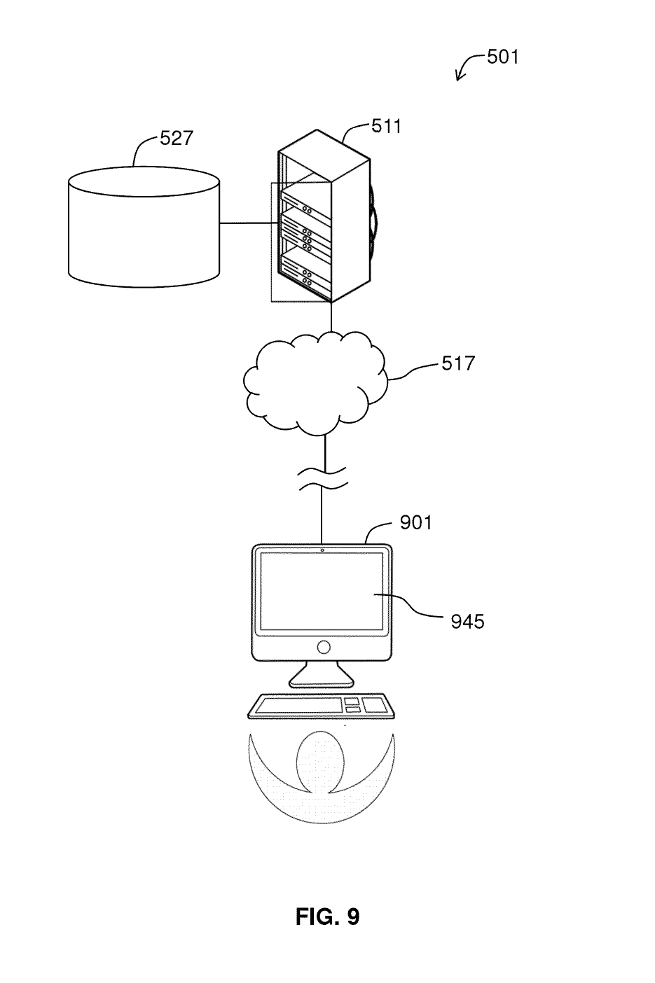

FIG. 9 depicts components of system 501 for use by an advertiser to access a campaign management tool. System 501 can execute software on server 511 to provide tools and functionality described herein. A business that wants to communicate offers to consumers can access the tools through the use of customer computer 901. Server 501 can send data and instructions causing display 945 on customer computer 901 to present information and receive input from a customer advertiser. As discussed above, a publisher may operate a media sharing platform to allow consumers to communicate by sharing digital media. A business may be customer of the publisher and may pay the publisher to send offers to the consumers. Systems and methods of the invention can be used to provide a business with campaign planning tools such as a “dashboard”, or home screen from which the business can plan an offer campaign.

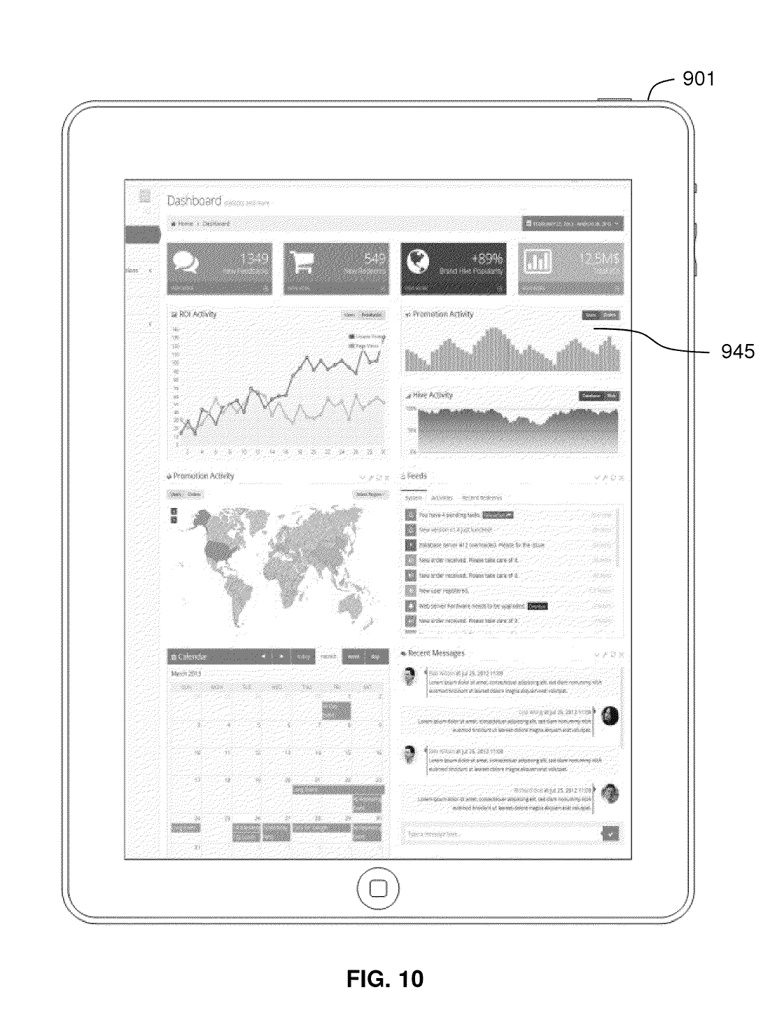

FIG. 10 illustrates a display 945 on a customer computer 901 that presents a dashboard from which a customer can plan an offer campaign. It should be noted that consumer computer 901 is depicted as a mobile device in FIG. 10 and as a desktop computer in FIG. 9. It will be appreciated that any suitable computer can be used including, for example, a laptop, a desktop, a smartphone, a tablet, or other. The dashboard shown on display 945 presents a number of different informative links and graphics for the business customer. One of the links may be presented to allow the customer to begin planning a campaign.

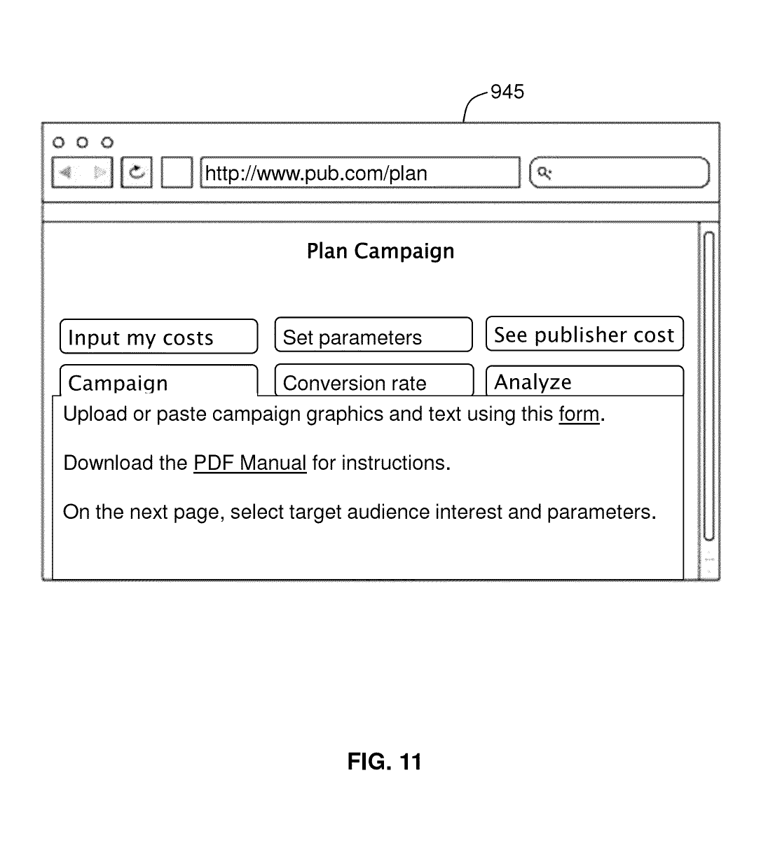

FIG. 11 depicts a display 945 presenting a tool for managing an offer campaign. Through such a tool, the invention provides a method and system to quantitatively design profit and investment side variables on a real-time basis to maximize potential return while minimizing the investment risk right from the initial stages of the campaign creation to execution. In a preferred embodiment, the tool provides the business with an aid in determining an optimal order quantity by identifying an ROI/risk associated with each of a plurality of order quantities. For example, in some embodiments, server 511 is used to model ROI as a function of order quantity and provide that information to the business customer while the business customer is planning a campaign. Using a tool of the invention, a business may determine or ascertain the ROI of their online and mobile marketing campaigns based on end-to-end data that may be sourced from such sources as a mobile communication platform, the business's knowledge input, an analytical module provided within the system, outside sources of information, or any combination thereof. End-to-end data relates to information gleaned about a consumer from prospect to conversion. Thus the business may predicate an ROI analysis on input variables both on the profit side and the investment side.

In certain embodiments, the invention provides real-time online simulation methods and systems, for example with a graphical user interface for automated marketing platforms, that provide optimal variable values in order to maximize the potential ROI/risk for browser and mobile marketing campaigns. In a preferred embodiment, the variable values such as order quantity are optimized at one or more fixed conversion rate. In a preferred embodiment, a 1% conversion rate is used by default. In some embodiments, other rates are used (e.g., to show different scenarios, or as provided or requested by a customer).

In some embodiments, systems and methods of the invention simulate a ratio of ROI to risk. In general terms, ROI is a measure of the profit earned from each investment. In simple terms, the calculation includes ((return-investment)/investment). ROI may be expressed as a percentage—i.e., as a convention the result may be multiplied by 100. The simulator can model a ratio of ROI to risk, where risk is defined as campaign cost for a campaign that produces no results (i.e., worst-case-scenario).

The ROI simulation tool provided by the invention may take many variables into consideration, both on the profit side (Price of the product/service, gross margin based on industry standards etc.) and the investment (expense) side (campaign design cost, execution cost etc.) to calculate return and investment values.

Unlike other ROI models, the systems and methods of the invention use values of input parameters that are either provided by the client or based on industry standards in mathematical formulas that simulate an ROI breakeven point (a pricing point at which the campaign could generate a positive return for a default conversion rate at a derived investment cost). The systems and methods then determine the optimal quantity to maximize the return (ROI) to risk (investment dollars with zero final sales) ratio. Thus, the invention provides the business customer with the capability of choosing the right quantity for a default conversion rate that maximizes the return to risk ratio while also providing the capability of minimizing investment dollars using real time simulation methods. An ROI simulation may begin with receiving, from the business customer or one or more other sources, any of a variety of inputs.

FIG. 11 shows a display 945 which a business customer may use to interact with an ROI simulator and provide input information. The ROI simulator provided by system 501 takes certain inputs and performs calculations. There can be inputs on the investment side and the return side that are used to calculate critical price points and provide the business with intuitive interactive displays useful for making decisions.

On the investment, or campaign expense side, the ROI may include fixed costs, variable costs, or both. Fixed costs may include, for example, design and consulting costs, tool licensing cots, analytics costs, others, or a combination thereof. Variable costs may include, for example, costs per unique impression, cost per unique click, cost per conversion, cost per transferred conversion, others, or a combination thereof.

On the return side, the ROI model may use input factors related to price of the product or service, discount price, gross margin by industry, based on industry standards, and calculated factors such as expected customer life time value and a conservative conversion rate.

The ROI breakeven price point is then determined by running simulations both on the return side (as applicable) as well as the expense side, and then utilized as an input to determine the optimal target reach to maximize the return to risk ratio for a default conversion rate. In some embodiments, the simulations are based on probability distributions and deterministic assumptions. The ROI breakeven price point can be used as an input to determine the optimal offer size to maximize the return to risk ratio for a default conversion rate. This allows the return on investment to risk ratio to be maximized based on optimal offer quantity from volume discount curves and the associated investment dollar risk at, e.g., 0% conversion. One insight of the invention is that publishers may apply volume discounts such that the marginal cost of an impression drops significantly as quantity increases. The application of volume discounts may contribute significantly to the peak of an ROI/risk over quantity curve not being at the highest quantity. Due to volume discounts, even assuming a 0% conversion, risk may be non-linear. Volume discount curves may be used to obtain risk at 0% conversion.

In a preferred embodiment, the ROI breakeven price point is determined by running simulations both on the return side as well as the expense side variables, and then utilized as an input to determine the optimal offer size to maximize the return-to-risk ratio for a default conversion rate. The ROI-to-risk ratio is then maximized based on optimal offer quantity derived from volume discount curves and the associated investment dollar risk at 0% conversion. The optimal offer quantity and the corresponding ROI-to-risk curve is then further adjusted (as applicable) for the expected total conversion tn (other than 0%) at different offer sizes using the following equation:

tn=c0*n*[1−(n/N)̂2+0.5*(n/N)̂3]

where c0 is the initial (default) conversion rate at ROI break even pricing, n is the number of offers, N is the number of potential customers for the offer. The number of potential customers for the offer N is based on several variables such as product price, discount value, available potential consumers for the offer, industry type, product inventory at the time of offer, offer delivery system effectiveness, others, or a combination thereof. Adjusting the curve may further include assuming that, for n≧N, tn=0.5*c0*N. By the foregoing preferred embodiment, risk is calculated as a function of number of offers.

Thus it will be appreciated that ROI can be modeled over a plurality of order quantities for one or more default conversion rates. Each modeled ROI can then be used in a ratio of ROI-to-risk, where risk is investment cost assuming a 0% conversion rate. It will be appreciated that the risk curve may not have the same slope throughout due to volume discounts. The resulting curve of ROI-to-risk (i.e., ROI/risk or ROI:risk) over order quantities for one or more different conversion rates may not be positively sloped throughout. In fact, economic theory and actual practice may reveal that the resulting simulated curves first have a positive-sloping portion and then also include a negative sloping portion. A maxima of such a curve may correspond to an optimal order quantity. It may be found that modeling ROI/risk (instead of ROI) is preferable as risk—campaign cost for a 0% conversion rate—factors in a probabilistic element that may be absent from ROI alone.

The output is displayed in graphical terms to demonstrate the relationship between such factors as target reach, ROI, campaign cost, or others at one or a variety of conversion rates.

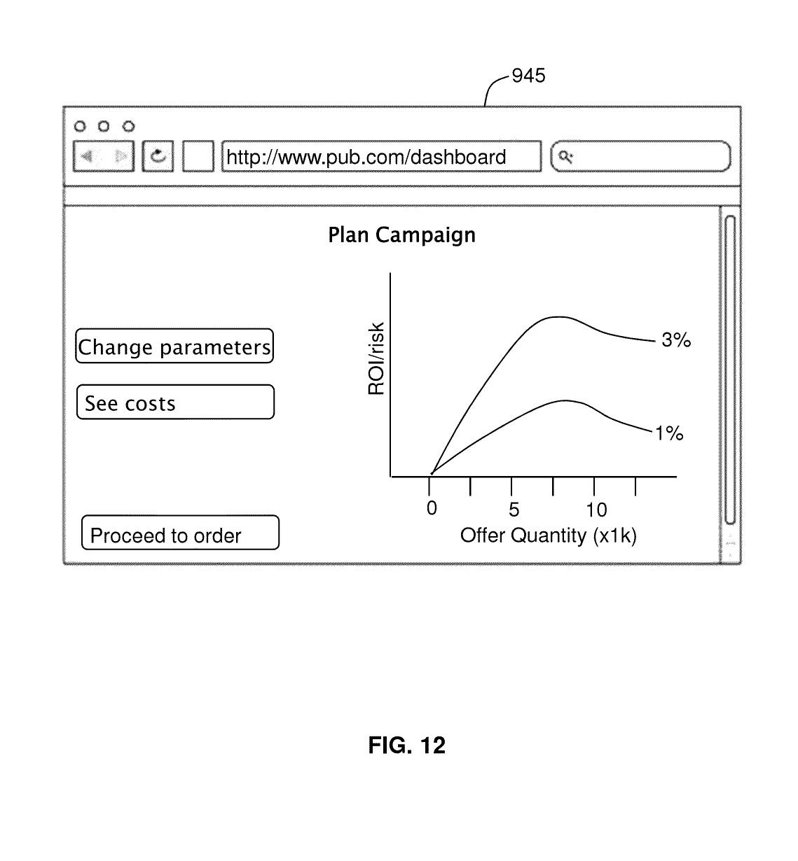

FIG. 12 illustrates a display 945 presenting a sample output of an ROI/risk simulator of the invention. In the presented example, a business customer has provided their input costs (e.g., how much they have spent in fixed costs to develop the offer that they will be communicating to consumers), return costs (e.g., discount cost—how much revenue will be “sacrificed” per offer redeemed), and other associated information. The ROI/risk simulator has calculated a simulated ROI as a function of impressions over an interval of 0 to 15,000 for two different hypothetical conversion rates—1% and 3%. The ROI is presented in a ratio of ROI to risk, or ROI/risk. Display 945 may optionally give the business customer tools for changing the model parameters (including changing input costs, conversion rates, etc.), seeing different campaign costs, or ordering a quantity of impressions. With reference back to the dashboard shown in FIG. 10, it can be seen that the offer campaign tool can provide a report of ongoing activity such as ROI for a particular in-progress campaign. Thus the ROI/risk simulator allows the business customer to make an informed decision at the initial stages of the campaign creation and also to monitor the results through execution. Using system 501, a publisher may engage a business customer and methods described herein of communicating an offer to a consumer may be performed.

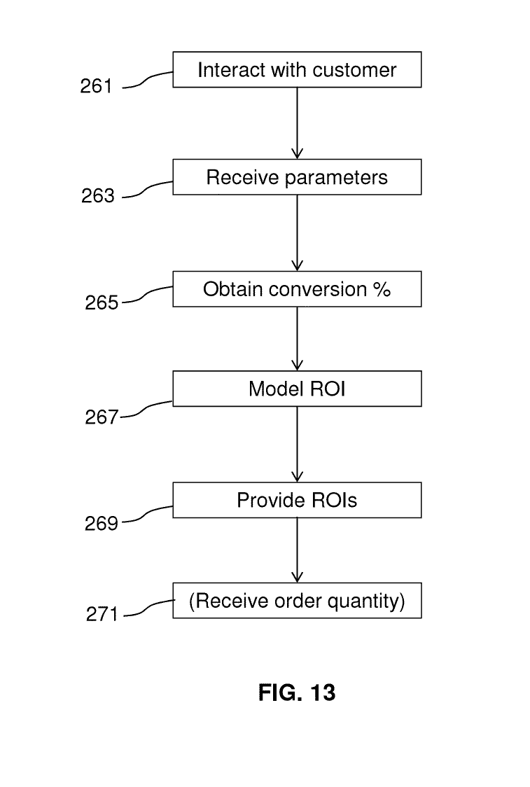

FIG. 13 diagrams steps of methods of the invention according to certain embodiments. System 501 is used to interact 261 with a business customer. For example, system 501 may present a dashboard as shown in FIG. 10. System 501 may then be used to receive 263 from a business customer parameters relating to their prospective offer campaign (e.g., through use of a campaign planning display 945 as shown in FIG. 11). That is, a publisher computer system may obtain campaign cost information from an advertiser business customer. System 501 will then obtain 265 a conversion rate to be used in ROI modeling. A conversion rate can be obtained by any suitable means for determining the rate (e.g., by input, but lookup in a table stored in a tangible memory in the system, or others). Preferably, the conversion rate includes a percentage of people that receive an offer who respond to the offer. In some embodiments, a default conversion rate (e.g., 1%) is used. As shown in FIG. 12, multiple different conversion rates can be modeled simultaneously. Once at least one conversion rate is obtained, system 501 is used to model 267 ROI by running one or more simulations or calculations. System 501 will model ROI at each of a plurality of different impression purchase quantities. For example, ROI can be modeled as a continuous or discontinuous function over a range of quantities. ROI can be modeled at two, three, or more discrete quantities. By modeling the ROI, the system can predict an ROI/risk to the customer for each of a plurality of impression quantities. The prediction is based on factors that include the campaign cost, an impression cost, and the conversion rate, wherein an impression includes showing the offer to a consumer via their mobile device. The factors may include prospect rate. Once the ROI is modeled for different quantities, system 501 will then provide 269 the modeled ROI values to the business consumer. Preferably the predicted or modeled ROI is provided as an ROI/risk ratio (optionally could be referred to as ROI:risk). In certain embodiments, the method includes providing the ROI/risk for each of the different impression purchase quantities to the advertiser customer. Once the modeled values have been provided to the business customer, the business customer has a valuable tool for making an informed decision as to what quantity of impressions to purchase for an offer campaign. For example, the customer may purchase a quantity, and system 501 may receive 271 the order quantity. For example, the system may receive from the customer an order for a quantity of impressions. It is noted that the modeled ROI values are presented to the customer (i.e., as ROI/risk) and the customer may then purchase the quantity associated with the highest ROI/risk but also that a customer may purchase some other quantity. Discussion suitable for modification for use with the invention may be found in U.S. Pat. No. 8,510,773 to Abou-Rizk; U.S. Pat. No. 7,729,940 to Harvey; U.S. Pat. No. 7,720,634 to Berstis; U.S. Pat. No. 7,668,950 to Horowitz; U.S. Pub. 2013/0046615 to Liyanage; U.S. Pub. 2013/0014137 to Bahatia; U.S. Pub. 2013/0014136 to Bhatia; U.S. Pub. 2011/005505 to Lang; U.S. Pub. 2010/0211460 to Agarwal; U.S. Pub. 2010/0145791 to Canning; U.S. Pub. 2008/0140522 to Tutone; U.S. Pub. 2006/0069613 to Agarwal; and U.S. Pub. 2002/0069079 to Vega, the contents of each of which are incorporated by reference for all purposes.

In a preferred embodiment, the method includes providing the user with an intuitive graphical user interface (GUI) that operates as a real-time, interactive ROI/risk simulator. Real-time may be taken to mean that a user can provide or change any certain input and have the associated ROI/risk for a plurality of different order quantities appear within seconds. Interactive can be taken to mean that the simulator provides and updates results in response to continuing and varying input from the user. A user can tweak an input parameter and see an updated result within a few seconds and can again tweak an input parameter.

One insight of the invention addressing a problem not recognized in the prior art is that publishers may derive substantial benefits from selling impressions and also giving business customers tools for choosing an order quantity other than simply the customer's maximum budget or the highest amount that the publisher can sell. Some may be skeptical that a publisher would want to seemingly down-sell by providing a tool (e.g., as shown in FIG. 12) that seems to reveal to the customer that an optimized purchase quantity is a quantity not associated with an immediate maximum revenue to the publisher. However, systems and methods of the invention provide a valuable service to publishers and customers in the form of a tool that aids a business customer in planning and executing an effective offer campaign. A business customer may use the tool to allocate the right amount of spend to a first offer campaign with precision and then to create a second campaign that otherwise would not have been affordable had the business customer purchased a maximum number of impressions in the first campaign.

The invention includes the insight that nimble, real-time campaign management tools have particular applicability in the context of mobile-based media sharing platforms. Consumers may be found to use mobile-based media sharing platforms as a primary means of communication. For example, some younger consumer may preferentially communication through the transmission of a picture, optionally with any associated text. These consumers thus may be highly receptive to receiving communication through the medium that they preferentially use for communication. Additionally, channeling communication among mobile devices 101a, 101b, . . . , 101n through server system 511, particularly where consumers have registered interests (see FIG. 3) or are categorizing communications (see FIG. 7C), provides a resource for targeting the communication of an offer with effective precision to a receptive consumer.

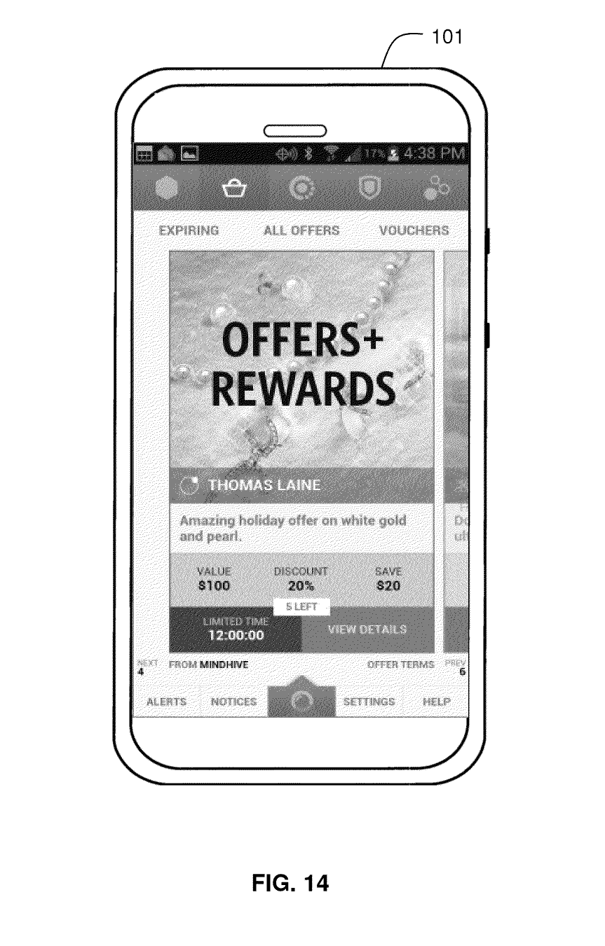

FIG. 14 illustrates a display on a device 101 through which a consumer may receive communications that include offers. As shown in FIG. 14, a consumer may have an ability to receive and review multiple offers (see, e.g., “All Offers” button). Individual offers and their terms can be displayed. For example, a consumer can be offered a product for $20 less than the product's usual retail price. In a preferred embodiment, an offer is a personalized discount or incentive offered to a consumer as opposed to an advertised sale price (although advertising a sale price may additionally or alternatively be accomplished using systems and methods of the invention). Because the offer is personalized, the customer business can use the offer campaign to engage high value prospect such as, for example, consumers who have expressed interests that overlap with the business's offerings or who have connected to or communicate with other certain participants in the platform. The offer campaigns described herein can be planned and executed using system 501.

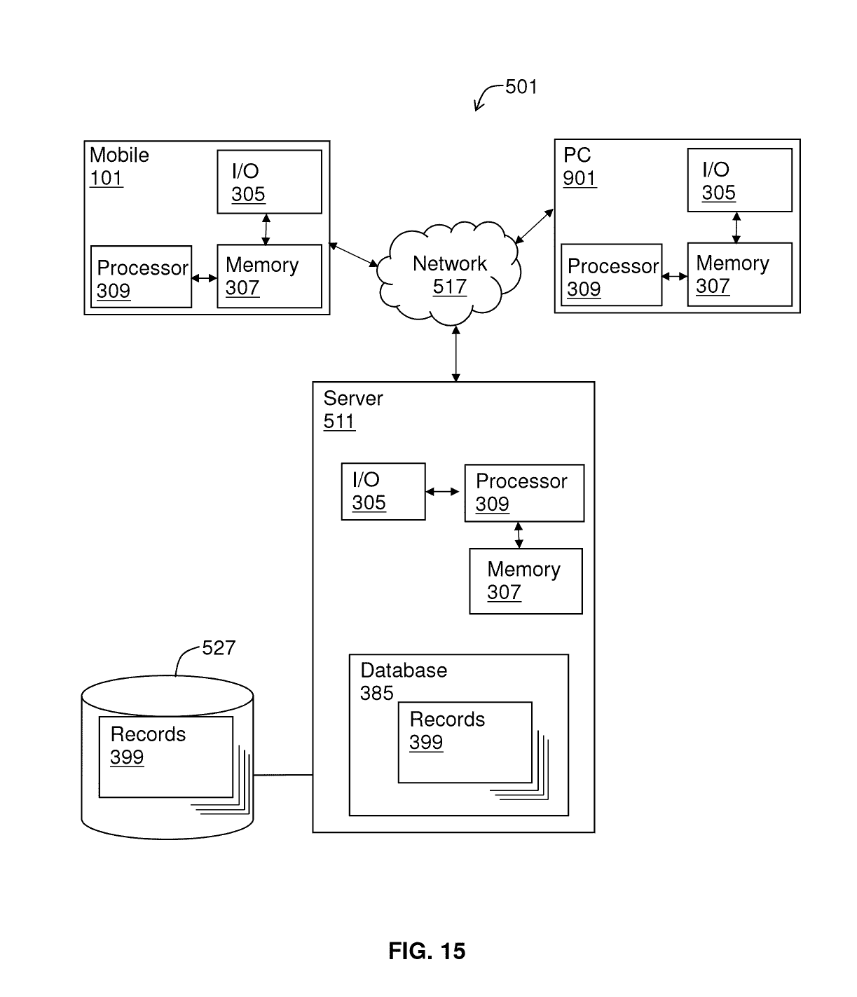

FIG. 15 gives a more detailed schematic of components that may appear within system 501. System 501 preferably includes at least one server computer system 511 operable to communicate with at least one mobile devices 101 via communication network 517. Sever 511 may be provided with a database 385 (e.g., partially or wholly within memory 307, storage 527, both, or other) for storing records 399 where useful for performing the methodologies described herein. Optionally, storage 527 may be associated with system 501. Components of system 501, such as server system 511, mobile 101, customer computer 901, are preferably each provided by a computer device. A computer generally includes at least one processor 309 coupled to a memory 307 via a bus and input or output devices 305.

As one skilled in the art would recognize as necessary or best-suited for performance of the methods of the invention, systems of the invention include one or more computer devices that include one or more of processor 309 (e.g., a central processing unit (CPU), a graphics processing unit (GPU), etc.), computer-readable storage device 307 (e.g., main memory, static memory, etc.), or combinations thereof which communicate with each other via a bus.

A processor 309 may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory 307 preferably includes at least one tangible, non-transitory medium capable of storing: one or more sets of instructions executable to cause the system to perform functions described herein (e.g., software embodying any methodology or function found herein); data (e.g., portions of the tangible medium newly re-arranged to represent real world physical objects of interest accessible as, for example, a picture of an object like a motorcycle); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, and any other tangible storage media.

Any suitable services can be used for storage 527 such as, for example, Amazon Web Services, memory 307 of server 511, cloud storage, another server, or other computer-readable storage. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to implement the methods described herein. For example, methods here in can be implemented using Perl, Python, C++, C#, Java, JavaScript, Visual Basic, Ruby on Rails, Groovy and Grails, or any other suitable tool. In a preferred embodiment, methods herein are implemented using PHP code. The PHP code returns JavaScript Object Notation (JSON) data. The JSON data may be interpreted in platform-specific or application-specific fashion on mobile device 101 or customer computer 901 using, e.g., either a web browser or a dedicated app. In some embodiments, tools accessed via a web browser are provided by using JavaScript to embed JSON data into HTML. For a mobile device 101, it may be preferred to use native xCode or Android Java.

As used herein, the word “or” means “and or or”, sometimes seen or referred to as “and/or”, unless indicated otherwise.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of planning communication on mobile devices, the method comprising:
receiving at a publisher computer system a set of communication campaign parameters;
simulating effectiveness as a function of units purchased for the received parameters, wherein a unit comprises an instance of causing a communication to be delivered via a mobile device;
providing the simulated effectiveness for a plurality of values for the units purchased; and
receiving from a customer an order to purchase a number of units.

2. The method of claim 1, wherein providing the simulated effectiveness comprises sending, to a customer computer, data comprising a ratio of return on investment to risk for the plurality of values and causing the customer computer to show the simulated effectiveness within a display.

3. The method of claim 1, further comprising showing the customer that an optimal effectiveness is provided by a number of units purchased lower than the highest of the plurality of values for the units purchased.

4. The method of claim 1, further comprising suggesting to the customer to purchase fewer than the highest of the plurality of values for the units purchased.

5. The method of claim 1, further comprising causing a customer computer to render a display that can be used by the customer to provide the campaign parameters and review the provided simulated effectiveness.

6. The method of claim 1, wherein effectiveness is defined to include a ratio of return to risk.

7. The method of claim 1, wherein simulating effectiveness comprises assuming a fixed value for a conversion rate and calculating a return based on the conversion rate, a publisher's impression cost, a customer's campaign cost, and optionally other variables.

8. The method of claim 7, wherein the communication comprises an offer and the conversion rate represents a hypothetical percentage of mobile device users to whom the offer is delivered who then redeem the offer.

9. A communication method comprising:
receiving at a publisher computer system campaign cost information from an advertiser;
determining a conversion rate to use, wherein conversion rate includes a percentage of people that receive an offer who respond to the offer;
predicting an ROI/risk ratio to an advertiser for each of a plurality of impression quantities, based on factors that include the campaign cost, an impression cost, and the conversion rate, wherein an impression includes showing the offer to a consumer via their mobile device;
providing the ROI/risk ratio for each of the different impression purchase quantities to the advertiser; and
receiving from the advertiser an order for a quantity of impressions.

10. The method of claim 9, wherein the factors further include prospect rate, the method further comprising causing an advertiser computer to render a display for use by the advertiser to provide the campaign cost information, review the ROIs, and order the quantity of impressions.

11. The method of claim 9, further comprising:
providing a digital media sharing service via a plurality of mobile devices;
obtaining—for a plurality of users of the sharing service—information about interests of various individual ones of the users; and
aiding, using the publisher computer system, the advertiser in targeting the offer based on the interests of the various individual ones of the users.

12. The method of claim 11, further comprising:
showing the advertiser a first quantity of impressions available for purchase; and
suggesting to the advertiser to purchase a second quantity of impressions lower than the first, wherein the first quantity is associated with a first ROI that is lower than the a second ROI associated with the second quantity.

13. The method of claim 9 further comprising allowing the advertiser to change the campaign cost information and updating the provided ROI within a few seconds of receiving the change.

14. The method of claim 9, wherein the campaign cost information comprises at least one selected from the list consisting of: campaign execution cost; product selling price; and discount price.

15. The method of claim 9, wherein providing the ROI for each of the different impression purchase quantities comprises causing an advertiser computer to display a graph of ROI/risk over impression quantity, the graph comprising a portion with a positive slope and a portion with a negative slope.

16. A system for communicating via mobile devices, the system comprising:
a publisher computer system comprising a tangible, non-transitory memory coupled to a processor, the system operable to:
receive from an advertiser a set of ad campaign parameters;
simulate return as a function of units purchased for the received parameters; and
provide the simulated return for a plurality of values for the units purchased to the advertiser.

17. The system of claim 16, further operable to show the customer that an optimal effectiveness is provided by a number of units purchased lower than the highest of the plurality of values for the units purchased.

18. The system of claim 16, further operable to suggest to the customer to purchase fewer than the highest of the plurality of values for the units purchased, wherein effectiveness is defined to include a ratio of return to risk.

19. The system of claim 16, wherein simulating effectiveness comprises assuming a fixed value for a conversion rate and calculating a return based on the conversion rate, a publisher's impression cost, a customer's campaign cost, and optionally other variables.

20. The system of claim 16, wherein the communication comprises an offer and the effectiveness is calculated based on a fixed conversion rate representing a hypothetical percentage of mobile device users to whom the offer is delivered who then redeem the offer.
